(19) United States
(12) Patent Application Publication
(10) Pub. No.: US 2019/0347069 A1
(43) Pub. Date: Nov. 14, 2019

(54) ACCESSING A DESKTOP COMPUTER WITH PROPRIOCEPTION

(71) Applicant: Nathan Park, Westerville, OH (US)

(72) Inventor: Nathan Park, Westerville, OH (US)

(21) Appl. No.: 15/977,248

(22) Filed: May 11, 2018

(51) Int. Cl. G06F 3/16; G06F 9/451; G06F 3/14; G06F 3/0481; G06F 3/0488

(52) U.S. Cl. CPC G06F 3/167; G06F 9/451; G06F 3/0488; G06F 3/04817; G06F 3/1423

(57) ABSTRACT

A method and system for allowing access to a computer system using an interface device employing proprioception is disclosed herein. The aspects disclosed in this application are related to employing an interface device with a touch display that allows engagement, and after doing so, provides audible cues associated with said engagement.

### BACKGROUND

A desktop computer is a power device that allows a user to ergonomically access the Internet through an interface device. Conventionally, the desktop computer has an interface device (or multiple interface devices), and a display device capable of generating digital content thereon.

FIG. 1 illustrates an exemplary computing device 100 according to a prior art implementation. As shown in FIG. 1, the computing device 100 includes a display 110, a keyboard 120, and a pointing device 130. These elements are commonly known in the art, and thus, a detailed description will be omitted.

However, the desktop computer essentially requires a user to view the elements they are interacting with to engage with said computer. Thus, visually impaired individuals may not have the ability to access said devices.

Further, other than typing devices and pointing devices, the ability to access a desktop computer has generally been limited. As such, many users not capable of using said typing device/pointing devices may be limited or ultimately frustrated from accessing the benefits associated with a desktop computer.

The inventor of this application, a visually impaired individual, has developed a new and novel way of interfacing with desktop computers, and has thus satisfied a void in interface devices that currently exists in the state of the art.

### SUMMARY

The following description relates to a system and method for accessing a desktop computer in a non-conventional manner, and specifically employing one's proprioceptive senses.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates an example of a desktop computer according to the prior art;

FIG. 2 illustrates a high-level depiction of a desktop computer employing the inventive aspects disclosed herein;

FIGS. 3(a)-(c) illustrate an example use case employing the aspects disclosed herein; and

FIG. 4 illustrates an example of a method for employing the desktop computer disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained in the background section, accessing a desktop computer may be difficult for individuals with a visual impairment. The primary limitation is that most interface devices incorporate a visual component. However, as each screen on a display 110 may be different, accessing said content may be difficult for those who are incapable of seeing said content.

Disclosed herein are methods and systems presented to overcome said difficulties. The aspects disclosed herein are directed to proprioception, which is related to the unconscious perception of movement and spatial orientation arising from stimuli within the body itself. By incorporating this sense into how the computer is accessed, the requirements associated with conventional interface devices are ultimately removed.

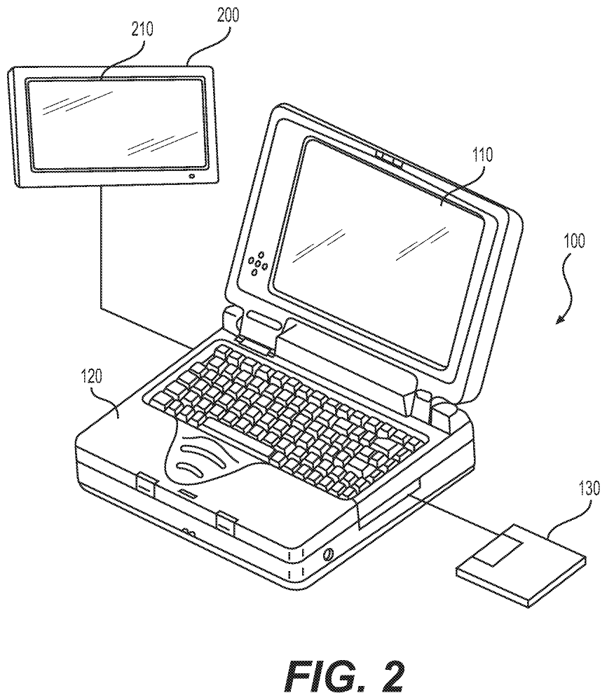

FIG. 2 illustrates an example of an interface device 200 electrically coupled to a desktop computer 100. The manner in which the interface device 200 couples to the desktop computer 100 may employ any known connection types, such as those commonly employed in the state of the art. Thus, the coupling may be either wired or wireless.

Also shown in FIG. 2, and included with the interface device 200 is a touch screen display 210. The touch screen display 210 allows engagement with the interface device 200 with any of the known touch technologies available via the state of the state of the art.

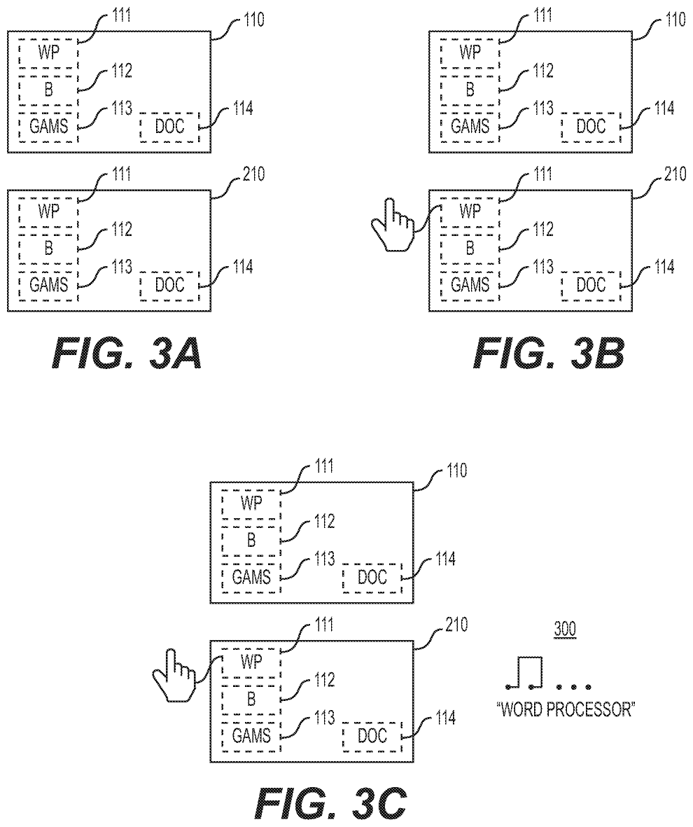

Now referring to FIGS. 3(a)-(c), an example use case will be explained with the illustration of the screens of display 110 and display 210. In FIG. 3(a), a screen shown on display 110 is reproduced significantly onto screen touch display 220, to a manner where the two screens are identical. As shown, there are a plurality of icons on display 110, with each icon, when selected, capable of opening an application or performing a command. As shown, icons 111-114 are each individually assigned to a respective task.

In FIG. 3(b), once a user (as shown by the hand) comes near the touch display 210 (through either direct touch or some other engagement technique), a specific command/icon may be selected.

In FIG. 3(c), once the user selects the appropriate or desired to select command, a audible signal 300 is produced providing some sort of indication that the command/icon has been selected. As shown, the user is selecting icon 111 on touch display 210, which is associated with a word processor command. Shortly thereafter, an audible sound 300 (employing either an audio device associated with the desktop computer, or one built into the interface device 200), generates a sound saying “word processor”. After the sound is presented, the user may double click the icon 111, thereby causing the desktop computer to open a word processor application.

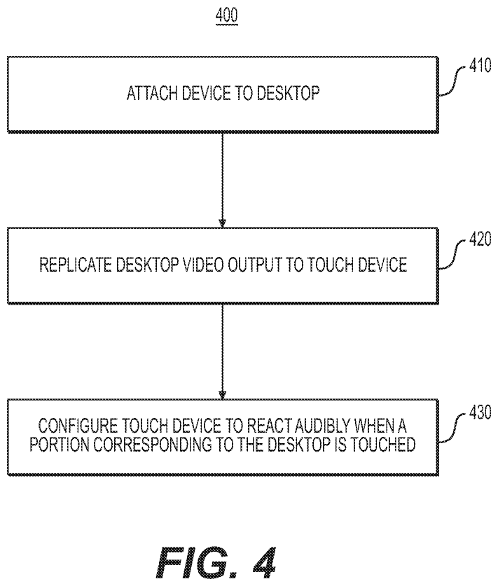

FIG. 4 illustrates a method 400 for implementing said interface device according to an exemplary embodiment. Referring to the method 400, the first step is electrically couple an interface device 200 to a desktop computer 100 (step 410). As mentioned above, the coupling may employ both wireless or wired techniques.

In step 420, the screen associated with a display 110 is replicated with a touch display 210 provided with the interface device 200. Thus, if the display 110 is a graphical user interface with a plurality of selectable and engage-able icons, this display is ultimately projected to said touch display 210.

In step 430, the interface device 200 is configured (for example, pre-programmed) to allow interaction employing the techniques shown in FIGS. 3(a)-(c). Thus, every time an icon/GUI is selected or asserted, an audible sound is produced that indicates what is being selected, with a second action actually being used to engage said icon/GUI.

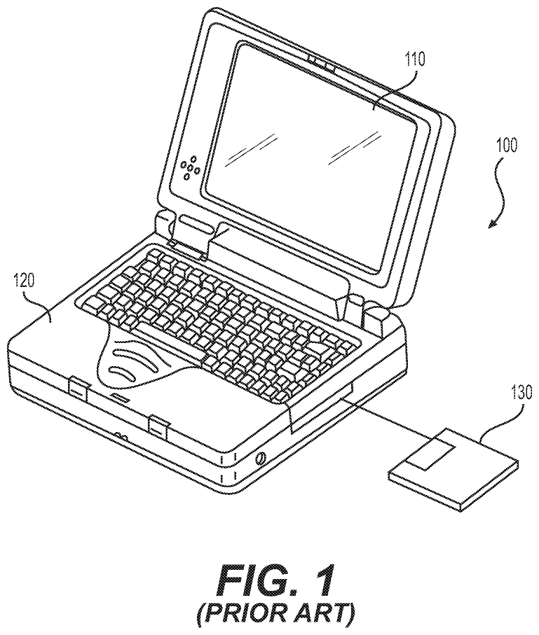

Certain devices shown in FIGS. 1-3(c) include a computing system. The computing system includes a processor (CPU) and a system bus that couples various system components including a system memory, such as read only memory (ROM) and random access memory (RAM), to the processor. Other system memory may be available for use as well. The computing system may include more than one processor or a group or cluster of computing systems networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that is accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 3 and 4. The disclosed devices, components, and systems contemplate using or implementing any suitable technique for performing the steps illustrated in these figures. Thus, FIGS. 3 and 4 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. An interface device for coupling to a computer system, comprising:
a connection means to allow the interface device to connect to the computer system;
a touch display embedded with the interface device;
a data store comprising a non-transitory computer readable medium storing a program of instructions for the correlating of the route;
a processor that executes the program of instructions, the instruction comprising the following steps:
in response to the interface device connecting to the computer system, replicating a display screen from the computer system to the interface device's touch display;
allowing icons from the display screen to be accessed via the interface device's touch display; and
in response to one of the icons being accessed via the touch display, generating an audible sound indicating said access.

2. The device according to claim 1, wherein the connection means is a physical wire.

3. The device according to claim 1, wherein the connection means is a wireless connection.

4. The device according to claim 1, wherein the audible sound is generated from a speaker embedded in the interface device.

5. The device according to claim 1, wherein the audible sound is generated from a speaker embedded in the computer system.
